(19) United States
(12) Patent Application Publication
(10) Pub. No.: US 2017/0193577 A1
(43) Pub. Date: Jul. 6, 2017

(54) SHOPPING MANAGEMENT SYSTEMS AND ASSOCIATED METHODS

(71) Applicant: PayPal Inc., San Jose, CA (US)

(72) Inventors: Sandra Lynn Godsey, San Jose, CA (US); Michael Charles Todasco, Santa Clara, CA (US)

(21) Appl. No.: 14/984,856

(22) Filed: Dec. 30, 2015

(51) Int. Cl. G06Q 30/06; G06Q 30/02; G06Q 50/00; G06K 19/07; G06Q 20/10

(52) U.S. Cl. CPC G06Q 30/0617; G06Q 30/0633; G06K 19/0723; G06Q 20/10; G06Q 50/01; G06Q 30/0279

(57) ABSTRACT

Embodiments of the present disclosure are related to shopping management systems and associated methods. A method may include receiving information regarding an item selected by a consumer. The method may also include determining if the detected item is a prohibited item. Further, the method may include performing at least one action if the detected item is a prohibited item.

### FIELD

The present disclosure relates generally to electronic commerce. More specifically, the present disclosure includes embodiments related to shopping management systems.

### BACKGROUND

Mobile electronic devices (e.g., smartphones) are increasingly being used in electronic commerce (e.g., to conduct electronic transactions online or at a physical store). As will be understood by a person having ordinary skill in the art, electronic commerce applications (e.g., electronic wallet applications) may include a software component and an information component, which may include, for example, a user's shipping address, billing address, and payment information/credentials including credit card numbers, expiration dates, and security numbers. To carry out an electronic transaction via an electronic commerce application, a customer (i.e., a consumer) may choose from various funding sources, such as different credit cards, bank accounts, debit cards, and the like.

As will be appreciated, some consumers may have a difficult time with disciplined adherence to a budget and/or avoiding purchases that may be detrimental to the consumer (e.g., detrimental to their health and/or their finances).

The subject matter claimed herein is not limited to embodiments that solve any disadvantages or that operate only in environments such as those described above. Rather, this background is only provided to illustrate one example technology area where some embodiments described herein may be practiced.

### BRIEF DESCRIPTION OF THE DRAWINGS

Example embodiments will be described and explained with additional specificity and detail through the use of the accompanying drawings in which:

FIG. 1 is a block diagram of a networked system, according to an embodiment of the present disclosure;

FIG. 2 is a block diagram of a computer system, according to an embodiment of the present disclosure;

FIG. 3 is a flowchart depicting a method, in accordance with an embodiment of the present disclosure; and

FIG. 4 is a flowchart depicting another method, in accordance with an embodiment of the present disclosure.

### DETAILED DESCRIPTION

Various embodiments, as described herein, relate to shopping management systems. According to one embodiment, a system may include a device configured to receive information (e.g., one or more attributes) for an item selected by a consumer. In one embodiment, the device may comprise at least one detection device (e.g., a barcode reader, a radio-frequency identification (RFID) reader, etc.) configured to receive the information upon an identifier affixed to the selected item being positioned proximate to the at least one detection device. In another embodiment, the device may configured to receive the information from a merchant after the consumer purchases the item. More specifically, for example, the device may comprise a wireless receiver configured to receive an electronic receipt including the information from the merchant.

The system may further include at least one application program configured to determine if a selected item is a consumer-defined prohibited item. As an example, the at least one application program may be configured to determine if the selected item is a prohibited item by comparing the selected item to a consumer-defined list of prohibited items. In addition, the application program may be configured to perform at least one action if the selected item is determined to be a prohibited item. If the selected item is determined to be a prohibited item, the application program may be configured to, for example only, modify an amount of funds available to the consumer, deduct funds from the consumer's shopping account, transfer funds from the consumer to another party, generate social media content related to selection of the item by the consumer, or any combination thereof.

According to other embodiments, the present disclosure includes methods for operating a shopping management system. Various embodiments of such a method may include receiving information regarding an item (e.g., one or more attributes of the item) selected by a user and determining if the selected item is a user-defined prohibited item. In one example, the information may be received from a merchant (e.g., via an electronic receipt) after the user has purchased the item from the merchant. In another example, the information may be received via at least one of barcode reader and/or a RFID reader of the user's mobile device (e.g., mobile phone). To determine whether the selected item is a user-defined prohibited item may include, for example, comparing the selected item to a user-defined list of prohibited items. Moreover, the method may include performing at least one action if the selected item is determined to be a prohibited item. As non-limiting examples, the at least one action may include modifying an amount of allocated funds to be spent by the user, deducting funds from the user's shopping account, transferring funds from the user to another party (e.g., donating funds to a charity), generating social media content related to selection of the item by the user, or any combination thereof.

In another embodiment, a method may include detecting an item selected by a consumer with a mobile device. As an example, the selected item may be detected by the mobile device via scanning a barcode affixed to the item, receiving a signal from a radio-frequency identification (RFID) tag affixed to the item, or both. The method may also include comparing information (e.g., information received via the barcode or RFID tag) for the detected item (e.g., one or more attributes, such as name and/or description of the item) to a list of prohibited items to determine if the detected item is a prohibited item. In one embodiment, the list of prohibited items may include a list of prohibited food items (e.g., unhealthy foods) as defined by a consumer. In another embodiment, the list of prohibited items may be defined by a third-party (e.g., a health/weight loss company (e.g. Weight Watchers™), a dietician, a doctor, a non-governmental organization (NGO), etc.) It is noted that, in one example, a consumer may provide a third-party with permission to define a list of prohibited items. Furthermore, the method may include performing at least one action if the detected item is determined to be a prohibited item. The at least one action may comprise, for example only, at least one of modifying an amount of funds available in a consumer account, deducting funds from the consumer's shopping account, transferring funds from the consumer to another party, displaying social media content related to selection of the item on a social media account of the consumer.

Yet other embodiments of the present disclosure comprise computer-readable media storage storing instructions that when executed by a processor cause the processor to perform instructions in accordance with one or more embodiments described herein.

Other aspects, as well as features and advantages of various aspects, will become apparent to those of skill in the art though consideration of the ensuing description, the accompanying drawings and the appended claims.

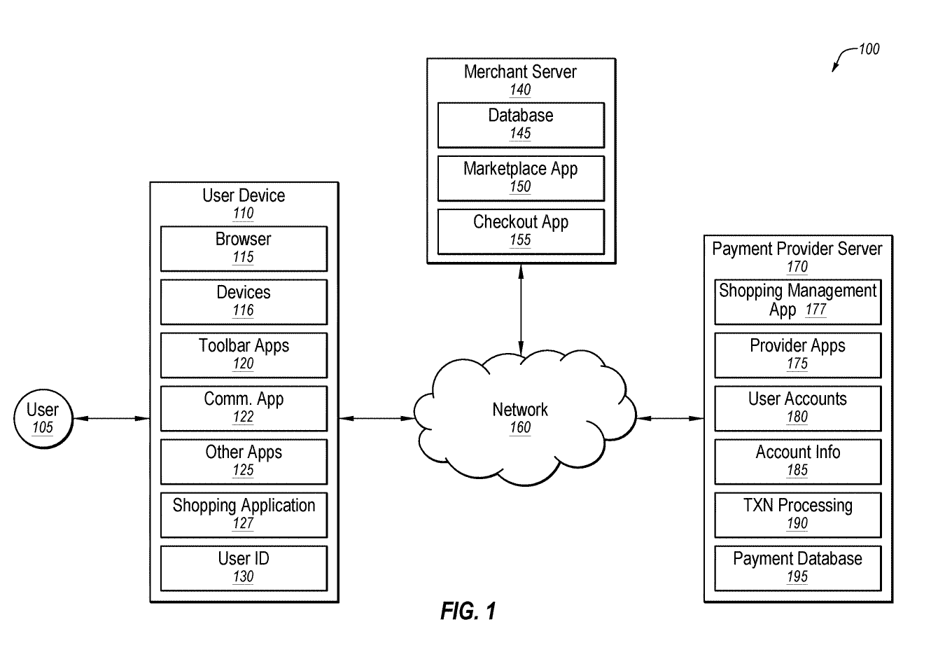

FIG. 1 is a block diagram of a networked system 100 configured for implementing a shopping management system, in accordance with various embodiments of the present disclosure. System 100 includes a user device 110, a merchant server 140, and a payment provider server 170 in communication via a network 160. Payment provider server 170 may be maintained by a payment provider, such as PayPal, Inc. of San Jose, Calif. A user 105, such as a consumer, may utilize user device 110 to perform a transaction using payment provider server 170. Note that transaction, as used herein, refers to any suitable action performed using user device 110, including payments, transfer of information, display of information, etc.

User device 110, merchant server 140, and payment provider server 170 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. For example, in one embodiment, user device 110 may be implemented as a personal computer (PC), a smart phone, personal digital assistant (PDA), laptop computer, and/or other types of computing devices capable of transmitting and/or receiving data, such as an iPad™ from Apple™.

User device 110 may include one or more browser applications 115, which may be used, for example, to provide a convenient interface to permit user 105 to browse information available over network 160. For example, in one embodiment, browser application 115 may be implemented as a web browser configured to view information available over the Internet. User device 110 may also include one or more toolbar applications 120 which may be used, for example, to provide user-side processing for performing desired tasks in response to operations selected by user 105. In one embodiment, toolbar applications 120 may display a user interface in connection with browser application 115 as further described herein.

User device 110 may further include other applications 125 as may be desired in particular embodiments to provide desired features to user device 110. For example, other applications 125 may include security applications for implementing user-side security features, programmatic user applications for interfacing with appropriate application programming interfaces (APIs) over network 160, or other types of applications. Other applications 125 may also include email, texting, voice and IM applications that allow user 105 to send and receive emails, calls, and texts through network 160, as well as applications that enable the user to communicate, transfer information, make payments, and otherwise utilize a shopping management system, as disclosed below.

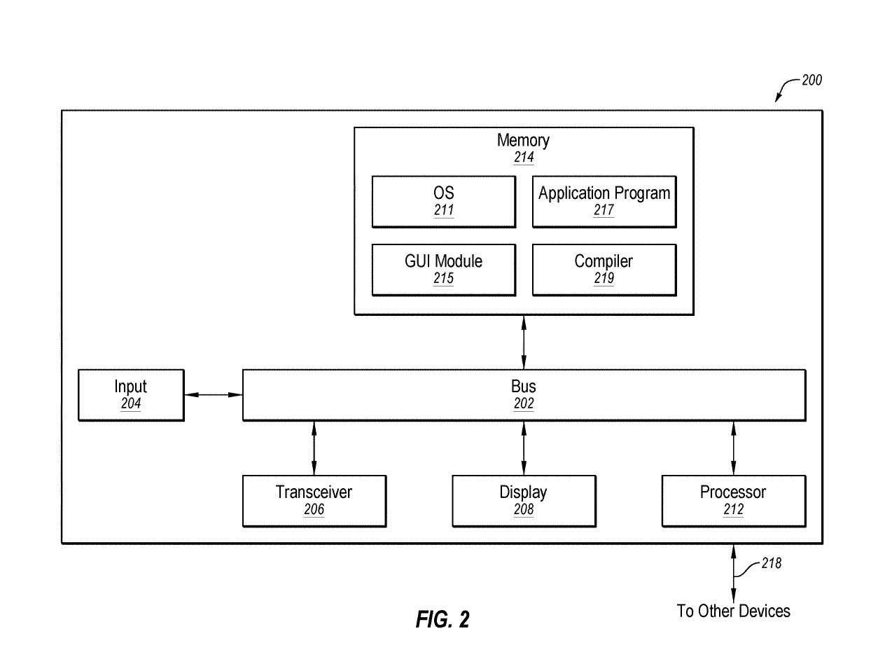

User device 110 may further include one or more applications (e.g., application program 217; see FIG. 2) for implementing one or more embodiments of a shopping management system, as described herein. For example, user device 110 may include at least a portion of a shopping application 127, and possibly a portion of a shopping management system 177, which may also exist on payment provider server 170.

User device 110 may include at least one device 116 (e.g., a barcode reader, a radio-frequency identification (RFID) reader, or both) configured to receive information regarding a shopping item via an identifier affixed to the shopping item. For example, device 116 may be configured to receive information regarding a shopping item via a barcode affixed to the shopping item, an RFID tag affixed to the shopping item, or both.

User device 110 includes one or more user identifiers 130, which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by a payment service provider to associate user 105 with a particular account maintained by the payment provider as further described herein. A communications application 122, with associated interfaces, enables user device 110 to communicate within system 100.

Merchant server 140 may be maintained, for example, by a merchant or seller offering various products and/or services in exchange for payment to be received over network 160. Merchant server 140 may be used for point of sale (POS) or online purchases and transactions. Generally, merchant server 140 may be maintained by anyone or any entity that receives money, which includes charities as well as retailers and restaurants. Merchant server 140 includes a database 145 identifying available goods and/or services (e.g., collectively referred to as items) which may be made available for viewing and purchase by user 105. Accordingly, merchant server 140 also includes a marketplace application 150 which may be configured to serve information over network 160 to browser 115 of user device 110. In one embodiment, user 105 may interact with marketplace application 150 through browser applications over network 160 in order to view various products, food items, or services identified in database 145.

Merchant server 140 also includes a checkout application 155 configured to facilitate the purchase by user 105 of goods or services identified by marketplace application 150. Checkout application 155 may be configured to accept payment information from or on behalf of user 105 through payment service provider server 170 over network 160, such as using selected funding instruments from an electronic commerce application. For example, checkout application 155 may receive and process a payment confirmation from payment service provider server 170, as well as transmit transaction information to the payment provider and receive information from the payment provider (e.g., a transaction ID).

Payment provider server 170 may be maintained, for example, by an online payment service provider which may provide payment between user 105 and the operator of merchant server 140. In this regard, payment provider server 170 includes one or more provider applications 175 which may be configured to interact with user device 110 and/or merchant server 140 over network 160 to facilitate the purchase of goods or services, communicate/display information, and send payments by user 105 of user device 110 and as discussed above.

Payment provider server 170 also maintains a plurality of user accounts 180, each of which may include account information 185 associated with individual users. For example, account information 185 may include information of users of devices such as account numbers, passwords, device identifiers, user names, phone numbers, credit card information, bank information, customized shopping plan information (e.g., list of prohibited shopping items, as defined by, for example, a user and/or a third party), and other information which may be used by user 105. Advantageously, provider application 175 may be configured to interact with merchant server 140 on behalf of user 105 during a transaction with checkout application 155 to track and manage purchases made by users and which funding sources are used.

A transaction processing application 190, which may be part of payment application 175 or separate, may be configured to receive information from user device 110 and/or merchant server 140 for processing and storage in a payment database 195. Transaction processing application 190 may include one or more applications to process information from user 105 for processing an order and payment using various selected funding instruments as described herein. As such, transaction processing application 190 may store details of an order associated with a phrase from individual users. Provider application 175 may be further configured to determine the existence of and to manage accounts for user 105, as well as create new accounts if necessary, such as the set-up, management, and use of an electronic wallet for user 105/user device 110.

Payment provider server 170 may further include an application program (e.g., application program 217; see FIG. 2) for implementing one or more embodiments of the present disclosure, as described more fully below. According to one example, payment provider server 170 may include at least a portion of a shopping management application 177, which may be part of a shopping management system, as described.

FIG. 2 is a block diagram of a computer system 200 suitable for implementing one or more embodiments of the present disclosure. It should be appreciated that each of user device 110, merchant server 140, and payment provider server 170 (see FIG. 1) may be implemented as computer system 200 in a manner as follows.

Computer system 200 includes a bus 202 or other communication mechanism for communicating information data, signals, and information between various components of computer system 200. Components include an input 204 that processes a user action, such as selecting keys from a keypad/keyboard (e.g., to customize a shopping plan of a shopping management system), selecting one or more buttons or links, etc., and sends a corresponding signal to bus 202. A transceiver 206 transmits and receives signals between computer system 200 and other devices, such as a merchant server, payment provider server, or another user device. In one embodiment, the transmission is wireless, although other transmission mediums and methods may also be suitable. A display 208, such as an LCD screen, displays an image via a graphical user interface (GUI). A processor 212, which can be a micro-controller, digital signal processor (DSP), or other processing component, processes these various signals, such as for display on computer system 200 or transmission to other devices via a communication link 218.

Generally, computer system 200 may operate under control of an operating system (OS) 211 stored in the memory 214, and interface with a user to accept inputs and commands and to present outputs through a GUI module 215. Although GUI module 215 is depicted as a separate module, the instructions performing the GUI functions may be resident or distributed in the operating system 211, an application program 217, or implemented with special purpose memory and processors. Computer system 200 may also implement a compiler 219 that allows application program 217 written in a programming language to be translated into processor 212 readable code. After completion, application program 217 may access and manipulate data stored in memory 214 of computer system 200 using the relationships and logic that are generated using compiler 219.

Further, operating system 211 and application program 217 may include instructions that, when read and executed by system 200, may cause system 200 to perform the steps necessary to implement and/or use embodiments of the present disclosure. Application program 217 and/or operating instructions may also be tangibly embodied in memory 214 and/or data communications devices, thereby making a computer program product or article of manufacture according to an embodiment of the disclosure. As such, the term “application program” as used herein is intended to encompass a computer program accessible from any computer readable device or media. Such a medium may take many forms, including but not limited to, non-volatile media, volatile media, and transmission media. In various implementations, non-volatile media includes optical or magnetic disks, volatile media includes dynamic memory, such as system memory 214, and transmission media may include coaxial cables, copper wire, and fiber optics, including wires that comprise bus 202. In one example, transmission media may take the form of acoustic or light waves, such as those generated during radio wave, optical, and infrared data communications.

Application program 217 may exist on an electronic device (e.g., user device 110; see FIG. 1) or a server (e.g., payment provider server 170; see FIG. 1). Furthermore, portions of application program 217 may be distributed such that some of application program 217 may be included on a computer readable media within an electronic device (e.g., user device 110) and some of application program 217 may be included on a server (e.g., payment provider server 170). In other embodiments, application program 217 may be configured to run on user device 110, payment provider server 170, another computing device, or any combination thereof. As a specific example, application program 217 may exist on payment provider server 170 and may be accessible to user 105 via user device 110.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by computer system 200. In various other embodiments of the present disclosure, a plurality of computer systems 200 coupled by communication link 218 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Various embodiments of the present disclosure are related to a shopping management system, which may allow a user (i.e., user 105; see FIG. 1) to customize a shopping plan (e.g., define shopping parameters, goals, budgets, rewards, penalties, etc.) to assist the user in achieving one or more goals (e.g., shopping and/or health goals). In accordance with various embodiments, the shopping management system may compare items selected and/or purchased by the user to the user's customized shopping plan, and based on the comparison, the shopping management system may provide the user with rewards (i.e., for avoiding (e.g., not purchasing) any items on a list of prohibited items) and/or penalties (i.e., for purchasing and/or selecting one or more of the items on the list of prohibited items). It is noted that the rewards and penalties may be defined by, for example, a user, a third party, or both.

As described more fully below, the shopping management system may be implemented via one or more application programs (e.g., application program 217; see FIG. 2), which may exist on a mobile device (e.g., user device 110), a server (e.g., payment provider server 170), or a combination thereof. More specifically, in one embodiment, an application program (e.g., shopping application 127; see FIG. 1), which may be configured to receive information regarding items selected and/or purchased by a user (e.g., via a barcode and/or a RFID tag), may be at least partially stored on a mobile device (e.g., user device 110). Further, a shopping management application (e.g., shopping management application 177; see FIG. 1), which may include a user's customized shopping plan, may be at least partially stored on a remote server (e.g., payment provider server 170).

As noted above, the shopping management system may be customizable by a user. For example, the shopping management system may allow a user to define a list of one or more prohibited items (e.g., unhealthy food items, tobacco, name brand goods, or any other item that the user wishes to avoid). For example, list of prohibited items (e.g., as defined by a user, a third party, or both) may include unhealthy food items, such as foods high in trans-fat, foods with high fructose corn syrup, food high in cholesterol, processed foods, snack items, or any other foods items that the user wishes to avoid. The shopping management system may further allow a user to define one or more parameters, as well as various penalties and/or rewards to be provided to the user for avoiding, or not avoiding, a prohibited item.

As one example, the shopping management system may allow a user (i.e., a consumer) to set a spending limit (e.g., per month) for an account (e.g., a spending account). Stated another way, a user may set a budget (e.g., monthly grocery shopping budget) for a shopping account. Further, each time the user selects a prohibited item and the prohibited item is detected (e.g., via RFID communication with an identifier affixed to the prohibited item, via scanning a barcode (e.g., universal product code (UPC) or stock keeping unit (SKU) code) affixed to the prohibited item, and/or purchasing a prohibited item, etc.), the spending limit may be modified (e.g., decreased).

As another example, the shopping management system may be configured to deduct an additional dollar amount from the user's shopping budget for purchasing a prohibited item (i.e., an amount in addition to an amount deducted to purchase the prohibited item). More specifically, for example only, if the user selects and/or purchases a prohibited item, such as a donut, which costs $1.00, the shopping management system may deduct an additional amount (e.g., double the price of the donut (i.e., $2.00)) from the user's shopping budget. Further, in one embodiment, the additional amount (i.e., $1.00 in this example) may be conveyed (e.g., via electronic transfer) to a third-party (e.g., the merchant, a charity, a political party, a family member, a friend, etc.), as defined by, for example, the user. It is noted that the third-party may or may not be a third-party that the user supports. For example, as extra incentive to the user, the third-party may comprise a political party or a charity that the user does not support and/or identify with.

In another embodiment, if the user attempts to purchase a prohibited item, the user's funding source (e.g., a credit card, a debit card, etc.) may be denied. For example, if the user attempt to purchase a donut and/or a pack of cigarettes, payment provider server 170 may cause the user's funding source (e.g., credit card) to be denied.

In yet another embodiment, the shopping management system may be configured to share information related to activity of a user (e.g., selecting a prohibited item) via one or more social media accounts. As an example, if a user selects a prohibited item, information related to the user's selection of the prohibited item may be “posted” or “shared” via one or more social media accounts (e.g., the user's social media accounts). As a more specific example, if the user positions a prohibited item in their shopping cart, and the prohibited item is detected (e.g., via RFID communication or via the user scanning a barcode of the prohibited item), social media content noting that the prohibited item has been selected by the user may be generated and posted to the user's social media account. As yet a more specific example, an image of the prohibited item (i.e., either an actual image of the prohibited item or a generic image of the prohibited item) may be shared to the user's social media account.

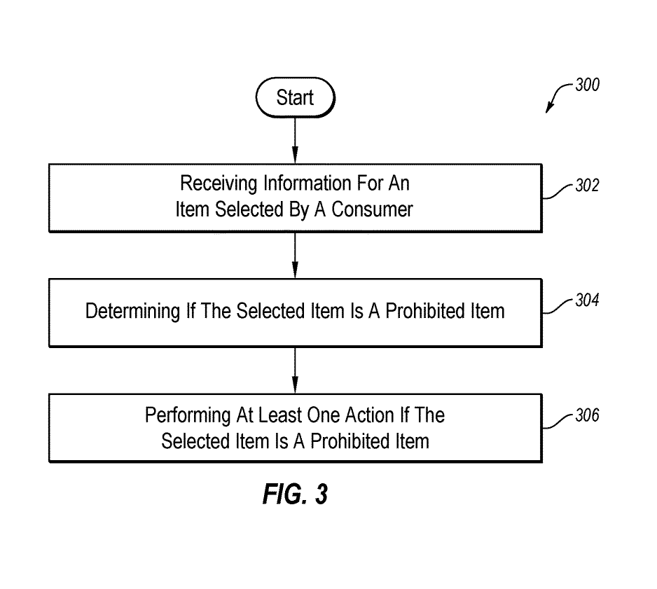

FIG. 3 is a flowchart illustrating an example method 300. Method 300 may be arranged in accordance with at least one embodiment described herein. Method 300 may be implemented, in some embodiments, by a system, such as the system 100 and/or 200 of FIGS. 1 and 2, respectively. Although illustrated as discrete blocks, various blocks of method 300 may be divided into additional blocks, combined into fewer blocks, or eliminated, depending on the desired implementation.

Method 300 may include receiving information for an item selected by a consumer (depicted at block 302). The information may include, for example, attributes of the selected item type that distinguish it from other item items. For a product, these attributes could include, but are not limited to, item name, description, material, size, color, nutritional content, and manufacturer. In one example, the information may be received from a merchant (e.g., via an electronic receipt) after the consumer has purchased the item from the merchant. In another example, the information may be received via at least one of barcode reader and/or a RFID reader of the consumer's mobile device (e.g., user device 110). It is noted that in one example, if an item remains with and/or near the consumer (e.g., in the consumer's shopping cart) for a defined time duration (e.g., one minute), the item may be deemed to have been selected by the consumer. In one example, the information may be conveyed from the consumer's mobile device (e.g., user device 110) to a remote server (e.g., server 170).

Method 300 may also include determining if the selected item is a prohibited item (depicted at block 304). Determining whether the selected item is a prohibited item may include, for example, comparing, at a remote server (e.g., server 170), the information regarding the selected item to a list of prohibited items.

Moreover, method 300 may include performing at least one action if the selected item is a prohibited item (depicted at block 306). As an example, the at least one action, which may be performed at a user device (e.g., user device 110 via shopping application 127), a server (e.g., server 170 via shopping management application 177), or both, may include modifying an amount of allocated funds to be spent by the consumer, deducting an additional amount from the consumer's shopping account (i.e., in addition to an amount to purchase the selected item), transferring funds from the consumer to another party (e.g., donating funds to a charity), generating social media content related to selection of the item by the consumer, or any combination thereof.

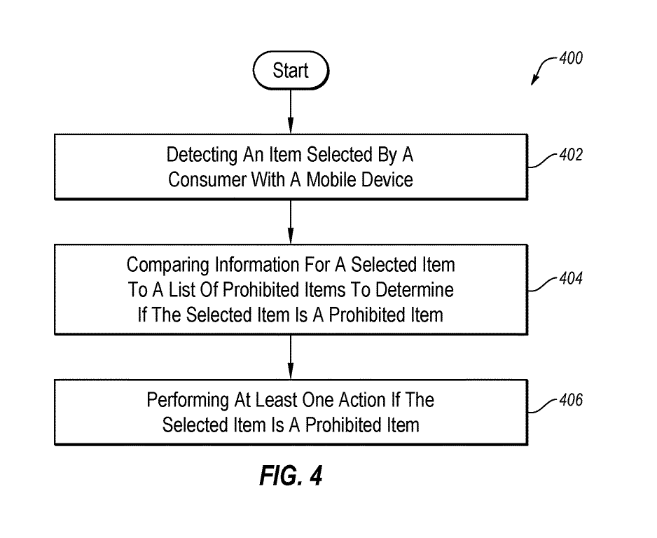

FIG. 4 is a flowchart illustrating another method 400, in accordance with one or more embodiments. Method 400 may be implemented, in some embodiments, by a system, such as the system 100 and/or 200 of FIGS. 1 and 2, respectively. Although illustrated as discrete blocks, various blocks of method 400 may be divided into additional blocks, combined into fewer blocks, or eliminated, depending on the desired implementation.

Method 400 may include detecting an item selected by a consumer with a mobile device (depicted at block 402). As an example, the selected item may be detected via communication between a barcode affixed to the selected item and a barcode scanner of the mobile device (e.g., user device 110), communication between an RFID tag affixed to the selected item and a RFID reader of the mobile device, or both. It is noted that in one example in which an RFID reader is used to detect an item, if the item remains with and/or near the consumer's mobile device (e.g., in the user's shopping cart) for a defined time duration (e.g., one minute), the item may be deemed to have been selected by the user.

Further, method 400 may include comparing information for a selected item to a list of prohibited items to determine if the selected item is a prohibited item (depicted at block 404). The information may comprise, for example, one or more attributes (e.g., name, description, etc.) of the selected item. In one embodiment, the information regarding the selected item may be conveyed to a remote server (e.g., server 170; see FIG. 1) where an application (e.g., shopping management application 177; see FIG. 1), may compare the information to the list of prohibited items to determine if the selected item is a prohibited item. In another embodiment, a local application (e.g., shopping application 127; see FIG. 1) may compare the information to the list of prohibited items to determine if the selected item is a prohibited item.

Moreover, method 400 may include performing at least one action if the selected item is a prohibited item (depicted at block 406). As an example, the at least one action, which may be performed at a user device (e.g., user device 110 via shopping application 127), a server (e.g., server 170 via shopping management application 177), or both, may include modifying an amount of allocated funds to be spent by the consumer, deducting an additional amount from the consumer's shopping account (i.e., in addition to an amount to purchase the selected item), transferring funds from the consumer to another party (e.g., donating funds to a charity), generating social media content related to selection of the item by the consumer, or any combination thereof.

It is noted that although various embodiments are described with reference to food items, the disclosure is not so limited. Rather, the shopping management system may be applicable to any items (i.e., any goods and services) that may be purchased by a user (i.e., consumer).

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

In some embodiments, the different components, modules, engines, and services described herein may be implemented as objects or processes that execute on a computing system (e.g., as separate threads). While some of the systems and methods described herein are generally described as being implemented in software (stored on and/or executed by general purpose hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc. are not necessarily used herein to connote a specific order. Generally, the terms “first,” “second,” “third,” etc., are used to distinguish between different elements. Absence a showing of a specific that the terms “first,” “second,” “third,” etc. connote a specific order, these terms should not be understood to connote a specific order.

All examples and conditional language recited herein are intended for pedagogical objects to aid the reader in understanding the disclosure and the concepts contributed by the inventor to furthering the art, and are to be construed as being without limitation to such specifically recited examples and conditions. Although embodiments of the present disclosure have been described in detail, it should be understood that various changes, substitutions, and alterations could be made hereto without departing from the spirit and scope of the present disclosure.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A system, comprising:
a device configured to receive information for an item selected by a consumer; and
at least one application program configured to:
determine if the selected item is a prohibited item of a list of prohibited items; and
perform at least one action if the selected item is a prohibited item.

2. The system of claim 1, wherein the device comprises at least one of a barcode reader and a radio-frequency identification (RFID) reader to receive the information upon the selected item being positioned proximate thereto.

3. The system of claim 1, wherein the list of prohibited items comprises a list of consumer-defined unhealthy food items.

4. The system of claim 1, wherein the at least one action comprises one or more of modifying an amount of allocated funds to be spent by the consumer, deducting funds from a consumer shopping account, transferring funds from one or more consumer accounts to a third party, generating social media content related to selection of the item by the consumer.

5. The system of claim 1, wherein the at least one application program is configured to determine if the selected item is a prohibited item via comparing the selected item to the list of prohibited items.

6. The system of claim 1, wherein the device is configured to receive the information from a merchant.

7. A method, comprising:
receiving information regarding an item selected by a consumer;
determining if the selected item is a prohibited item; and
performing at least one action if the selected item is a prohibited item.

8. The method of claim 7, wherein receiving comprises receiving the information at a mobile device via at least one of a radio-frequency identification (RFID) reader and a barcode reader.

9. The method of claim 8, wherein determining comprises determining if the selected item is a prohibited item at a server remote from the mobile device.

10. The method of claim 7, wherein receiving comprises receiving the information via at least one of a radio-frequency identification (RFID) tag affixed to the item and a barcode affixed to the item.

11. The method of claim 7, wherein performing comprises at least one of modifying an amount of allocated funds to be spent by the consumer, deducting funds from an account owned by the consumer, transferring funds from the consumer to another party, generating social media content related to selection of the item by the consumer.

12. The method of claim 7, wherein determining comprising comparing the selected item to a list of prohibited items.

13. The method of claim 7, wherein receiving comprises receiving the information from a merchant after the consumer has purchased the item.

14. The method of claim 7, wherein performing at least one action comprises transferring an amount of money from the consumer to a charity if the detected item is determined to be a prohibited item.

15. One or more non-transitory computer-readable media storing one or more programs that are configured, when executed, to cause one or more machines to execute the method as recited in claim 7.

16. A method, comprising:
detecting an item selected by a consumer with a mobile device;
comparing information of a selected item to a list of prohibited items to determine if the detected item is a prohibited item; and
performing at least one action if the detected item is a prohibited item.

17. The method of claim 16, wherein detecting comprises at least one of detecting a barcode affixed to the item and detecting a radio-frequency identification (RFID) tag affixed to the item.

18. The method of claim 16, wherein performing comprises performing at least one action as defined by the consumer.

19. The method of claim 16, wherein performing comprises at least one of modifying an amount of funds available in a consumer account, deducting funds from the consumer account, transferring funds from the consumer account to another party, displaying social media content related to selection of the item on a social media account of the consumer.

20. One or more non-transitory computer-readable media storing one or more programs that are configured, when executed, to cause one or more machines to the execute the method as recited in claim 16.
